(19) United States
(12) Patent Application Publication
(10) Pub. No.: US 2012/0311837 A1
(43) Pub. Date: Dec. 13, 2012

(54) MOUNTING MECHANISM FOR TOUCH SCREEN

(75) Inventor: XIN-YAN WANG, Shenzhen City (CN)

(73) Assignees: FIH (Hong Kong) Limited, Kowloon (HK); SHENZHEN FUTAIHONG PRECISION INDUSTRY CO., LTD., ShenZhen City (CN)

(21) Appl. No.: 13/331,715

(22) Filed: Dec. 20, 2011

(30) Foreign Application Priority Data
Jun. 10, 2011 (CN) 201110155363.9

(51) Int. Cl. B23P 19/00

(52) U.S. Cl. 29/281.3

(57) ABSTRACT

A mounting mechanism for mounting a touch screen to a housing includes a positioning module, a cover and a press module. The positioning module includes a base board and a positioning portion used to position the housing. The cover is hinged to the base board. The press module includes a first pressing board, a positioning stand used to position the touch screen and first elastic elements clamped between the cover and the first pressing board. The cover defines a through hole with a slidably mounted positioning stand. When the cover is rotated to resist against the base board, the touch screen is positioned opposite to the housing on the positioning portion, the first elastic elements are compressed until the screen is mounted on the housing by a pressing force provided on the first pressing board.

### BACKGROUND

1. Technical Field

The disclosure generally relates to mounting mechanisms for mounting touch screens to housings.

2. Description of the Related Art

A touch type electronic device such as touch type mobile phone may include a housing and a touch screen mounted on the housing. Conventionally, the touch screen is manually mounted on the housing. However, it is difficult to ensure the touch screen is mounted at the correct housing position.

Therefore, there is room for improvement within the art.

### BRIEF DESCRIPTION OF THE DRAWINGS

Many aspects of the exemplary mounting mechanism for touch screen can be better understood with reference to the following drawings. The components in the various drawings are not necessarily drawn to scale, the emphasis instead being placed upon clearly illustrating the principles of the exemplary mounting mechanism for touch screen. Moreover, in the drawings, like reference numerals designate corresponding parts throughout the diagrams.

FIG. 1 is an isometric view of a mounting mechanism for a touch screen according to an exemplary embodiment.

FIG. 2 and FIG. 3 are similar to FIG. 1, but the mounting mechanism for a touch screen is in use.

### DETAILED DESCRIPTION

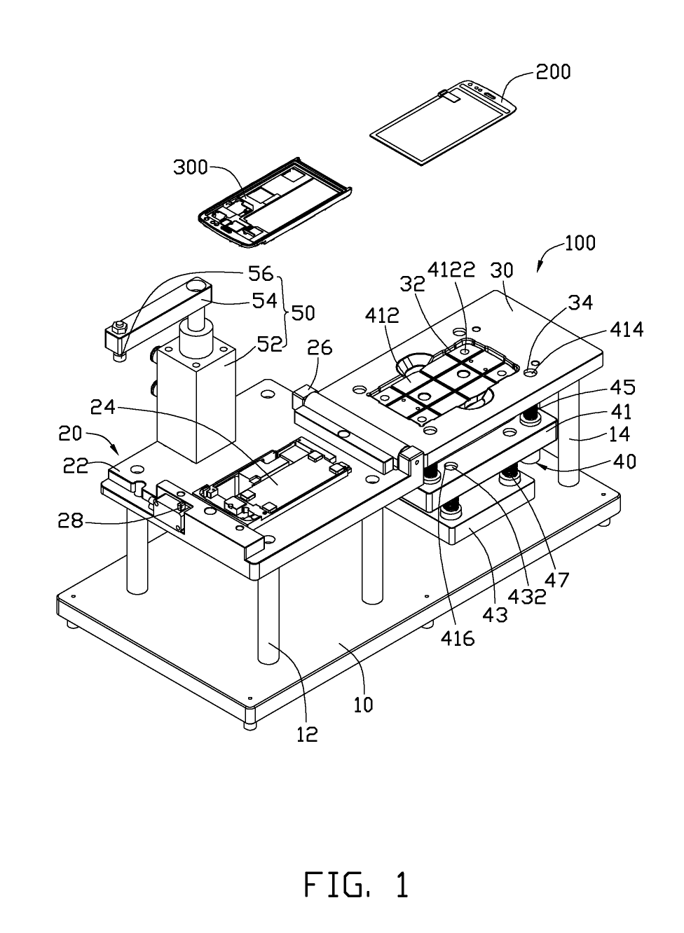

FIG. 1 shows an exemplary mounting mechanism 100 used to mount a touch screen 200 on a housing 300. The mounting mechanism 100 includes a base body 10, a positioning module 20 fixed on the base body 10, a cover 30 hinged on the positioning module 20, a press module 40 mounted on the cover 30 and a driving module 50 mounted on the positioning module 20.

The base body 10 includes a number of first supporting posts 12 and a number of second supporting posts 14. The first supporting posts 12 support the positioning module 20. The second supporting posts 14 support the cover 30.

The positioning module 20 includes a base board 22, a positioning portion 24, a hinge portion 26 and a switch 28. The base board 22 is fixed on the first supporting posts 12. The positioning portion 24 is located between the hinge portion 26 and the switch 28. The positioning portion 24 positions the housing 300. The hinge portion 26 hinges with the cover 30. The switch 28 prevents the driving module 50 from being mis-triggered.

The cover 30 is hinged on the hinge portion 26. The cover 30 defines a through hole 32 and first guide holes 34 around the hole 32. The first guide holes 34 guide the movement of the press module 40.

The press module 40 includes a first pressing board 41, a second pressing board 43, first elastic elements 45 and second elastic elements 47. The first elastic elements 45 are clamped between the cover 30 and the first pressing board 43. The second elastic elements 47 are clamped between the first pressing board 43 and the second pressing board 47. The elasticity of the second elastic elements 47 is larger than the first elastic elements 45.

The first pressing board 41 has a positioning stand 412 and first guide pins 414 projecting from the surface located near the cover 30. The positioning stand 412 is located among the first guide pins 414 at a uniform position from the first guide pins 414. The positioning stand 412 is slidably mounted in the through hole 34. The positioning stand 412 defines vacuum holes 4122 for providing a vacuum to facilitate the attachment of the screen 200 onto the supporting stand 412. Each first guide pin 414 is slidably mounted in a first guide hole 34, and each first elastic element 45 is coiled around a first guide pin 414. The first pressing board 41 further defines second guide holes 416. The second guide holes 416 guide the second pressing board 43 to move towards the first pressing board 41.

The second pressing board 43 has second guide pins 432 projecting from the surface located near the first pressing board 41. The distance between each second pressing board 43 and the center of the second pressing board 43 is uniform. Each second guide pin 432 is slidably mounted in a second guide hole 416, and each second elastic element 47 is coiled around a second guide hole 432.

The driving module 50 includes a driver 52, a connecting arm 54 and a pressing head 56. The connecting arm 54 connects the driver 52 and the pressing head 56. The driver 52 drives the connecting arm 54 to rotate to face the second pressing board 43 and drives the pressing head 56 to press onto the second pressing board 43.

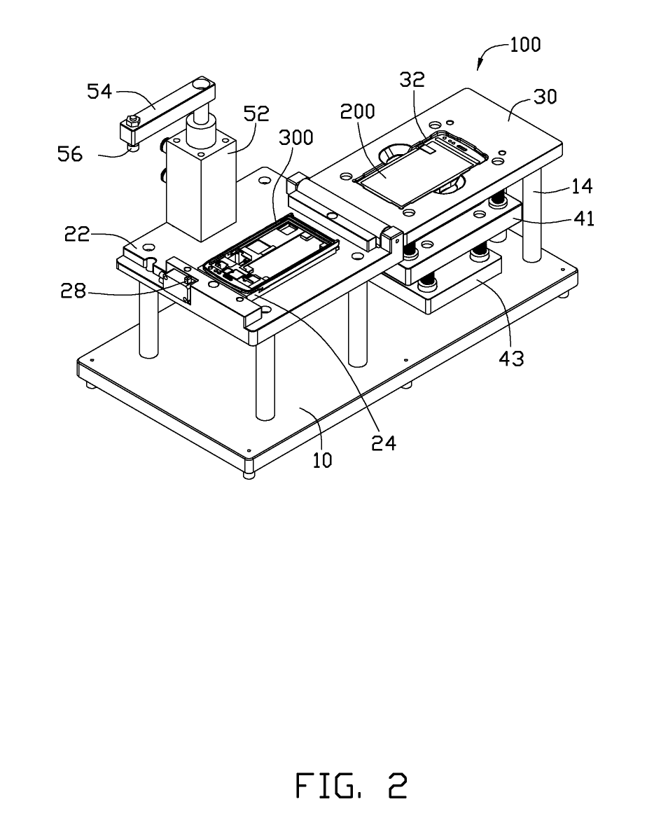

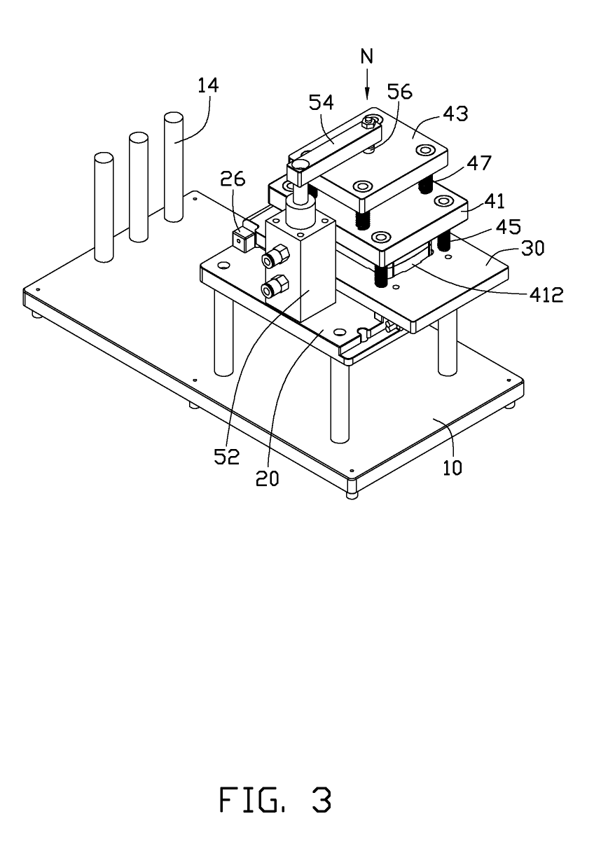

FIGS. 2 and 3, in use of the touch screen mounting mechanism 100, the cover 30 is rotated away from the base board 22 and resists against the second supporting post 14. Adhesive is spread on the the surface of the housing 300, for mounting the screen 200. The housing 300 is positioned on the positioning portion 24. The screen 200 is positioned on the positioning stand 412, and the supporting stand 412 holds the screen 200 with vacuum suction force from the vacuum holes 4122. The cover 30 is rotated to be pressed on the positioning portion 24 and triggers the switch 28. At this time, the screen 20 is located opposite to the surface of the housing, which is pasted with adhesive.

The driver 52 is triggered to drive the connecting arm 54 and the pressing head 56 to rotate until the pressing head 56 is positioned opposite to the center of the second pressing board 43. The driver 52 drives the pressing head 56 to provide a press force labeled with an “N” onto the second pressing board 43. The second pressing board 43 transmits the press force N to the first pressing board 41 by the second elastic elements 47. The second elastic elements 47 are then compressed to accumulate an elastic force. The press force N drives the screen 200 held on the supporting stand 412 to press onto the housing 300. The first elastic elements are also compressed to accumulate an elastic force. When the adhesive between the housing 300 and the screen 200 is solidified, the screen 200 is already mounted on the housing 300. The driver 52 drives the pressing head 56 to move away from the second pressing board 43. The first pressing board 41 and the second pressing board 43 return their original positions by the release of the elastic force.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A mounting mechanism for mounting a touch screen to a housing, comprising:
a positioning module comprising a base board and a positioning portion positioning the housing;
a cover hinged to the base board and defining a through hole; and
a press module comprising a first pressing board, a positioning stand positioning the touch screen, and first elastic elements clamped between the cover and the first pressing board, the positioning stand slidably mounted in the through hole;
wherein, when the cover is rotated to resist against the base board, the touch screen is positioned on housing on the positioning portion, the first elastic elements are compressed until the screen is mounted on the housing by a pressing force provided on the first pressing board.

2. The mounting mechanism as claimed in claim 1, wherein the first pressing board comprises first guide pins located around the positioning stand, each first elastic element is coiled around corresponding one first guide pin, the cover defines first guide holes, each first guide pin is slidably mounted in corresponding one first guide hole.

3. The mounting mechanism as claimed in claim 2, wherein the distance between each first guide pin and the positioning stand is uniform.

4. The mounting mechanism as claimed in claim 1, wherein press module further comprises a second pressing board and second elastic elements, the second elastic elements are clamped between the first pressing board and the second pressing board, and the first pressing board is located between the cover and the second pressing board.

5. The mounting mechanism as claimed in claim 4, wherein the second pressing board has second guide pins projected from a surface, each second elastic element is coiled around corresponding one second guide pin, the first pressing board defines second guide holes located around the positioning stand, each second guide pin is slidably mounted in corresponding one second guide hole.

6. The mounting mechanism as claimed in claim 5, wherein the distance between each second guide hole and the positioning stand is uniform.

7. The mounting mechanism as claimed in claim 4, wherein the elasticity of the second elastic elements is bigger then the first elastic elements.

8. The mounting mechanism as claimed in claim 4, wherein the mounting mechanism further comprises a driving module mounted on the base board, the driving module comprises a driver, pressing head and a connecting arm connecting the driver and the pressing head, the driver is used to rotate the pressing head to face the second pressing board and then provide the pressing force.

9. The touch screen mounting mechanism as claimed in claim 8, wherein the positioning module further comprises a switch for preventing the driving module from being mis-triggered.

10. The mounting mechanism as claimed in claim 1, wherein the positioning module further comprises a hinge portion, the cover is hinged on the hinge portion, and the positioning portion is located between the switch and the hinge portion.

11. The mounting mechanism as claimed in claim 1, wherein the positioning module further comprises a base, first supporting posts and second supporting posts, the first supporting posts and the second supporting posts are projected from the base, the base board is fixed on the first supporting posts, the second supporting posts is used to support the cover.

12. The mounting mechanism as claimed in claim 1, wherein the positioning stand defines vacuum holes for providing vacuum to facilitate the attachment of the screen onto the supporting stand.
